(19) United States
(12) Patent Application Publication
(10) Pub. No.: US 2006/0087629 A1
(43) Pub. Date: Apr. 27, 2006

(54) Optical lens elements, semiconductor lithographic patterning apparatus, and methods for processing semiconductor devices

(75) Inventors: Jennifer Stone-Sundberg, Portland, OR (US); Richard L. Johnson, Madison, OH (US); Milan R. Kokta, Washougal, WA (US); Jeffrey Cooke, Camas, MA (US)

Correspondence Address: TOLER & LARSON & ABEL L.L.P., 5000 PLAZA ON THE LAKE STE 265, AUSTIN, TX, 78746, US

(73) Assignee: SAINT-GOBAIN CERAMICS & PLASTICS, INC., Worcester, MA (US)

(21) Appl. No.: 11/255,594

(22) Filed: Oct. 21, 2005

Related U.S. Application Data
(60) Provisional application No. 60/621,002, filed on Oct. 21, 2004.

(51) Int. Cl. G03B 27/00

(52) U.S. Cl. 355/18; 430/313; 355/77

(57) ABSTRACT

An optical lens element is disclosed, formed of single crystal spinel material, the optical element having an optical transmittance of not less than 75%. Also, a lithographic patterning apparatus is disclosed, including a radiation source and a mask having a pattern arranged downstream of the radiation source, the mask receiving radiation to provide a patterned beam. Further, a projection optic for projecting the patterned beam onto a substrate is provided, the projection optic having multiple optical lens elements, at least one of which is comprised of single crystal spinel material, and a substrate table for receiving the substrate is provided. In addition, methods for processing semiconductor devices are disclosed.

### CROSS-REFERENCE TO RELATED APPLICATION(S)

This application claims priority to U.S. Provisional Application 60/621,002, filed Oct. 21, 2004, the subject matter thereof being incorporated herein by reference in its entirety.

### BACKGROUND

1. Field of the Disclosure

The present invention is generally directed to optical lens elements, semiconductor lithographic apparatuses incorporating same, and methods for processing semiconductor devices. In particular, the present invention relates to use of new materials in the context of optical lens elements, semiconductor lithographic patterning apparatuses, and methods for processing semiconductor devices.

2. Description of the Related Art

In the art of semiconductor processing, great strides have been achieved over the past few decades relating to the density, speed and sophistication of semiconductor devices. Of the many technologies that have come together to enable formation of such highly sophisticated modern semiconductor devices, semiconductor patterning through lithographic processing remains an area of intense focus and often times represents a barrier for achieving next generation critical dimensions (CDs) in modern semiconductor devices. Presently, state of the art semiconductor devices are being fabricated in the sub 0.25 micron (250 nm) range, this value often times being referred to as critical dimension (CD), design rule, or node. The ever-present pressure in the industry for more dense semiconductor devices having greater operating speeds and sophistication dictates even continued reduction of critical dimension. An on-going challenge in the development of next generation semiconductor devices, such as sub 100 nm CD and smaller, is the development and deployment of lithographic techniques that have adequately high resolution and desirably high depth of focus to accommodate varying wafer topologies.

Turning specifically to lithographic processing, in the past fifteen years the industry has moved past G-line photolithographic processing (sub-1.0 micron node), past I-line processing (0.35 micron node), to DUV (deep ultra-violet; 248 nm wavelength, 0.18 node), to presently a further refinement in DUV, operating at the 193 nm wavelength (0.1 μm; 100 nm node). Continued industry demands dictate further reduction in CD, and it is envisioned that new generation lithography techniques should enable reduction to the 32 nm node and below.

In an attempt to extend the viability of continued use of current generation 193 nm technology, the industry has presently developed so-called immersion photolithography technologies, in which a fluid is provided between the projection optic of the lithographic apparatus and the substrate, typically a semiconductor wafer containing multiple semiconductor devices in the form of die regions. Immersion lithography has been shown to improve or enhance resolution over conventional projection lithography in which the space between the projection optic and the substrate is simply air. In more detail, traditionally the light source wavelength and numerical aperture (NA) have dictated the resolution of a lithography system. NA is derived from the equation NA=n sin(q), where n is the refractive index of the medium through which the exposure light passes and q is the angle of the light. Under normal lithographic processing, n=1 (air). In immersion lithography, in contrast, a liquid that has a refractive index grater than 1 is introduced between the projection optic and the wafer, thereby increasing NA by increasing refractive index (n). Accordingly, with the same angle of incidence, the minimum resolution can be reduced (improved).

While immersion lithography has been demonstrated to improve semiconductor processing, a need continues to exist in the art for further enhancements, including in the context of immersion lithography, to enable the industry to approach the benchmarks for next generation technology.

### BRIEF DESCRIPTION OF THE DRAWINGS

The present disclosure may be better understood, and its numerous features and advantages made apparent to those skilled in the art by referencing the accompanying drawings.

FIG. 1 illustrates a lithographic apparatus according to an embodiment of the present invention.

FIG. 2 illustrates an exemplary optical element lens structure associated with a projection optic.

FIG. 3 illustrates a containment structure to enable immersion lithography.

FIG. 4 illustrates stepping and scanning processing pathways for lithographic processing.

FIG. 5 illustrates a semiconductor device in the form of a semiconductor die region having a pattern.

FIG. 6 illustrates an optical lens element.

The use of the same reference symbols in different drawings indicates similar or identical items.

### SUMMARY

According to one aspect, an optical lens element is formed of single crystal spinel material, the optical element having an optical transmittance of not less than 75%.

According to another aspect, a lithographic patterning apparatus includes a radiation source, a mask having a pattern arranged downstream of the radiation source, the mask receiving radiation to provide a patterned beam, and a projection optic for projecting the patterned beam onto a substrate. The projection optic includes multiple optical lens elements, at least one of which is comprised of single crystal spinel material. A substrate table for receiving the substrate is also provided.

According to another aspect, a method of processing a semiconductor device includes providing a photoresist on a semiconductor device, and irradiating a patterned beam onto the semiconductor device to expose portions of the photoresist, wherein irradiating includes projecting the patterned beam through a projection optic. The projection optic includes multiple optical lens elements, at least one of which is formed of single crystal spinel material.

According to another aspect, a lithographic patterning apparatus includes a radiation source, a mask having a pattern arranged downstream of the radiation source, the mask receiving radiation to provide a patterned beam, and a projection optic for projecting the patterned beam onto a substrate. The projection optic includes multiple optical lens elements, at least one of which is comprised of a material having an index of refraction greater than about 1.55 at 193 nm. A substrate table for receiving the substrate is also provided.

According to another aspect, a method of processing a semiconductor device includes providing a photoresist on a semiconductor device, and irradiating a patterned beam onto the semiconductor device to expose portions of the photoresist, wherein irradiating includes projecting the patterned beam through a projection optic. The projection optic includes multiple optical lens elements, at least one of which is formed material having an index of refraction greater than about 1.55 at 193 nm.

### DETAILED DESCRIPTION OF THE DRAWINGS

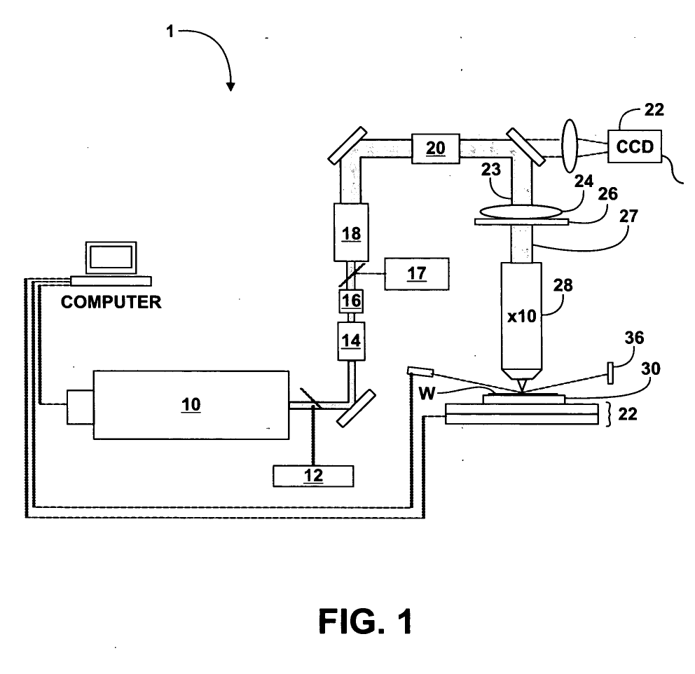

According to a first embodiment, a lithographic patterning apparatus is provided, which may find use in the semiconductor processing industry for forming current and next-generation semiconductor devices. The basic structure of the apparatus is shown in FIG. 1. Lithographic patterning apparatus 1 is configured to pattern semiconductor devices, typically a plurality of semiconductor die regions still in wafer form, by utilizing a particularly chosen wavelength of radiation generated by radiation source 10. The radiation source 10 can be chosen from any one of several sources adapted to generate a target wavelength or wavelength range. The wavelength may be G-line, I-line (365 nm), or DUV (248 nm). Typically, the wavelength is not greater than 300 nm, and in some cases not greater than 200 nm. According to a particular embodiment, the radiation source 10 generally provides a relatively small wavelength for high resolution, such as 193 nm, 157 nm, or even smaller wavelengths. In the context of 193 nm radiation, it may be particularly suitable to utilize an ArF laser source.

The generated radiation is then conditioned through a series of optical devices designed to modify the radiation to have desired uniformity and homogeneity, as well as polarity and bandwidth. As illustrated in the embodiment shown in FIG. 1, the conditioning optics may include spectrometer 12, polarizer 14, variable attenuator 16, dose monitor 17, beam shaping optics 18, and homogenizer 20.

Following conditioning of the radiation, the conditioned beam 23, monitored by laser beam profiler 22 having a CCD (charge coupled device) array, passes through a condenser lens 24, and then past reticle 26. Reticles are understood in the art, and are formed to have a desired pattern, which is to be projected onto the semiconductor device. As the radiation passes the reticle 26, the beam is then patterned (patterned beam or radiation 27), and is in an appropriate form for projection onto the substrate, generally a semiconductor wafer. The patterned beam 27 is then passed through a projection optic 28, which typically contains a plurality of optical lens elements. The projection optic 28 may be refractive or catadioptric. According to a particular embodiment, the projection optic is entirely refractive, which may provide benefits over catadioptric projection optics in terms of throughput, accuracy and distortion. The thus patterned and projected beam is then irradiated onto wafer W provided on wafer table 30, which itself rests on XYZ air-bearing stages 22. The wafer table 30 shown in the drawings is provided for illustration only, and it is to be understood that the substrate or wafer table may be in any form that is suitable for receiving and supporting the substrate, and may include clamping-type structures.

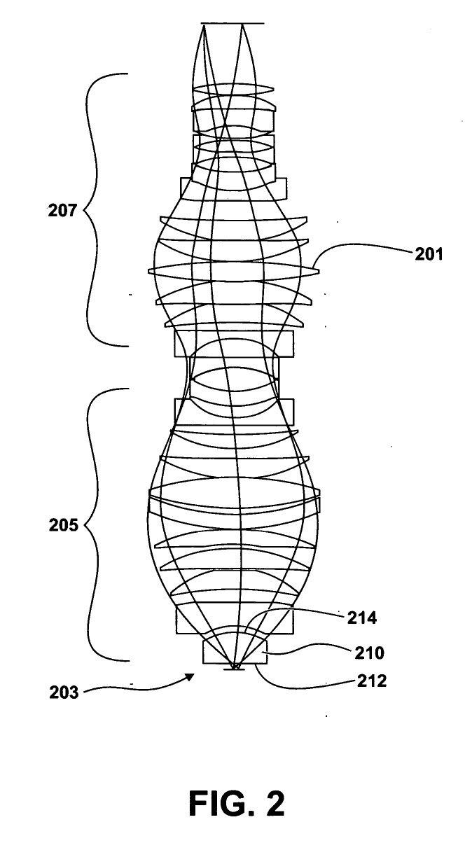

Turning to FIG. 2, the optical element lens structure associated with projection optic 28 is illustrated. As shown, multiple optical lens elements are stacked on each other in the form of a stacked array, optical lens elements 201 forming a high fluence region 207 and a low fluence region 205. The end of the projection optic 28 facing the substrate or wafer W is referred to as the distal end 203. The distal optical lens element 210 shown in FIG. 2 has a generally planar exterior major surface 212 and a convex interior major surface 214. It is noted that the actual number of optical lens elements 201 may vary, and the particular arrangement may vary widely. In addition, the distal optical lens element 210 may also have a different configuration including convex and/or concave opposite major surfaces, for example. The optical lens elements may be formed of fused silica, or single crystalline materials such as CaF. Particular materials for certain elements, such as the distal optical lens element 210, are described below.

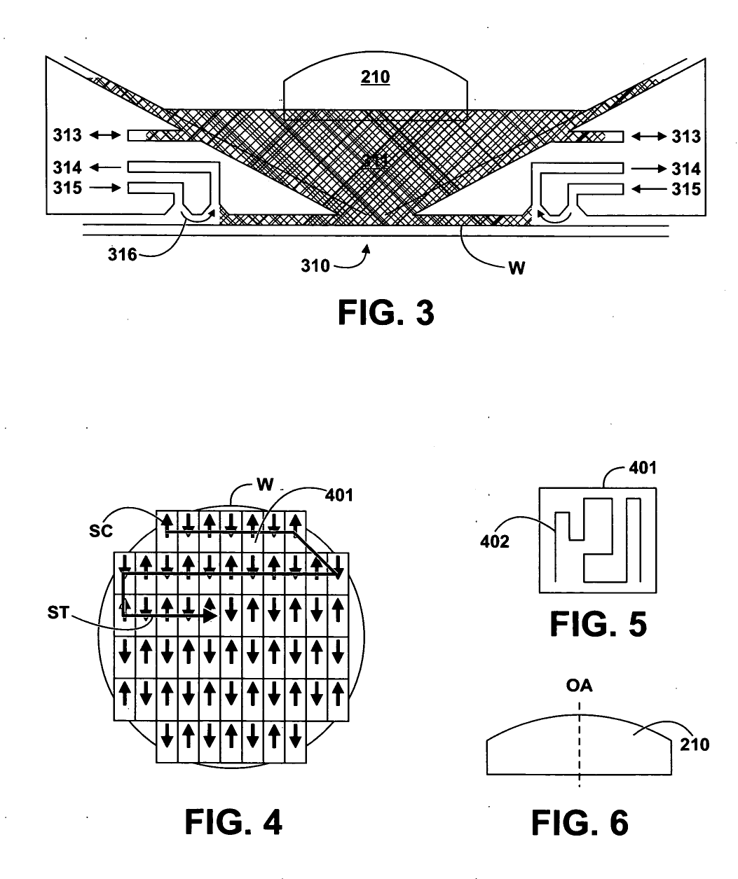

According to a particular implementation of the embodiment shown in FIG. 1, the lithographic patterning apparatus may take advantage of immersion technology. In this context, FIG. 3 illustrates a containment structure to enable immersion processing. The containment structure is provided between the substrate table 30 and the projection optic 28. In the particular embodiment illustrated in FIG. 3, the containment structure is in the form of a reservoir 310 containing a liquid 311. As illustrated in FIG. 3, the projection optic 28, particularly the distal optical lens element 210 is positioned to be at least partially immersed in liquid 311. The remaining structure associated with reservoir 310 is generally related to managing fluid flow during lithographic processing, and may include inlet/outlet ducts 313, outlet 314, and inlet 315. Additionally, a seal device 316 is provided between the outlets and inlets 314, 315 respectively. Additional details regarding the particular structure shown in FIG. 3 may be found in U.S. Patent Publication 2004/0160582, published Aug. 19, 2004, incorporated herein by reference.

According to embodiments of the present invention, the liquid 311 has an index of refraction higher than that of air, and generally has an index of refraction greater than about 1.3 at 193 nm. In this regard, deionized water is a particularly suitable liquid for immersion technology, having a refractive index of 1.435 at 193 nm. However, fluids having an higher index of refraction than deionized water may also be utilized, including aqueous solutions of various fluids such as HCl, CSCl, H₂SO₄, NaHSO₄, CS₂SO₄, Na₂SO₄, H₃PO₄. These fluids, in aqueous concentrations ranging from 10-90%, typically 20-90% may provide even further enhancement of index of refraction, and even further resolution of the lithographic apparatus.

Processing of semiconductor devices typically involves provision of a photoresist on the semiconductor device. As noted above, the semiconductor devices are generally in the form of a plurality of die in the form of a wafer, which may be 200 mm, 300 mm, or even larger diameter semiconductor wafers. Following any requisite metrology mapping of the wafer, the wafer is positioned on the substrate table 30 with the aid of wafer height registration components 36, and air-bearing stages 32, which may be translated by CNC (computer numerical control) with assistance of the computer illustrated in FIG. 1 in X, Y, and Z directions.

Turning to FIG. 4, the general methodology of exposure of the plurality of semiconductor die regions 401 on wafer W is illustrated. Here, arrow ST represents the stepping direction, in which the air bearing stages 32 are manipulated in the ST direction to “step” from one semiconductor die region to the next. At each die region, exposure takes place by scanning along direction SC. Scanning is carried out in an alternating pattern as shown for ease of process control. The foregoing process is known as a “step and scan” process, readying the wafer for later stage processing.

Following step and scan processing, semiconductor processing generally continues with development of the photoresist, optionally preceded by a baking operation. Following development, a pattern is left behind. The pattern provided corresponds to selectively removed portions of the photoresist (the same as or the negative of the pattern of the beam, depending on whether a positive or negative photoresist is used). The pattern formed by the removed photoresist exposes selective portions of the semiconductor device, oftentimes in a maze-like fashion, well understood in the art of lithographic processing. An example of a pattern for illustration purposes only is shown in FIG. 5, showing a single semiconductor die region 401 having a pattern 402.

Following patterning of the photoresist as described above, the wafer is generally subjected to a material removal process, in which the exposed portions of the semiconductor device are selectively removed. Here, etching such as reactive ion etching or plasma etching is carried out to react a volatile species such as a halogen (or alternatively a heavy metal) with the exposed material of the semiconductor device, typically a dielectric such as silicon dioxide or silicon nitride, or polysilicon. The reacted species are volatilized and thereby removed from the semiconductor device. Following removal of the photoresist, later stage processing may include deposition of a material, oftentimes a conductive material such as tungsten, aluminum, or copper. This material may then be planarized, such as through known chemical mechanical planarization (CMP) techniques. Thereafter, processing may continue with further deposition, patterning, etching and planarization steps to form the desired final physical structure of the semiconductor device. Upon completion of those steps, typically the die regions are diced into a plurality of individual die, which are then packaged and integrated into a larger scale electronic devices.

Turning back to FIG. 2 and FIG. 6, attention is drawn to distal optical lens element 210. According to a particular feature, the distal optical lens element 210 has a index of refraction greater than calcium fluoride. Typically, the index of refraction of the distal optical lens element 210 is greater than about 1.55 at 193 nm. In addition, the distal optical lens element may have an optical transmittance at the working wavelength of the lithographic apparatus that is relatively high, such as not less than about 75%, not less than about 80% or not less than about 85%. As noted above, the working wavelength of the lithographic apparatus is less than 300 nm, and oftentimes less than 200 nm. Specific examples include 248 nm, 193 nm, and 157 nm. Desirably the foregoing optical transmittance and index of refraction characteristics are associated with whatever wavelength is utilized for the lithographic patterning apparatus. Unless otherwise noted, 193 nm is used as the standard associated with the foregoing values, but it is to be understood that the particular optical lens element may be utilized at other wavelengths, including next generation 157 nm processing and later generation processing.

According to a particular aspect, the optical lens element is formed of a single crystal material. In one embodiment, the single crystal material is single crystal spinel, having an index of refraction within a range of about 1.60 to 1.80 at 193 nm. Processing to form the single crystal spinel optical lens element generally begins with the formation of a batch melt in a crucible. The batch melt is generally provided to manifest a desired composition in the as formed spinel material, generally in the form of a “boule,” describing a single crystal mass formed by melt processing, which includes ingots, cylinders and the like structures. According to one embodiment, the boule has a general formula of aAD.bE₂D₃, wherein A is selected from the group consisting of Mg, Ca, Zn, Mn, Ba, Sr, Cd, Fe, and combinations thereof, E is selected from the group consisting Al, In, Cr, Sc, Lu, Fe, and combinations thereof, and D is selected from the group consisting O, S, Se, and combinations thereof. In one embodiment, a ratio b:a=about 1:1 such that the spinel is stoichiometric. Stoichiometric spinel is particularly useful for forming optical lens elements as described herein. Other embodiments are non-stoichiometric, and may be rich in E₂D₃, such that b:a>1:1. In this context, certain embodiments have a b:a ratio not less than about 1.2:1, such as not less than about 1.5:1. Techniques for forming non-stoichiometric spinels are described in U.S. patent application Ser. No. 10/802,160, filed Mar. 17, 2004 (Atty Docket Number 1075-BI4309), incorporated herein by reference.

According to certain embodiments, A is Mg, D is O and E is Al, such that the single crystal spinel has the formula aMgO.bAl₂O₃. While disclosure contained herein may make reference to the MgO—Al₂O₃ spinel based-compositions, it is understood that the present disclosure more generally relates to a broader group of spinel compositions, having the generalized formula aAD.bE₂D₃ as described above.

Following formation of a batch melt in a crucible, typically, the spinel single crystal boule is formed by one of various techniques such as the Czochralski pulling technique. While the Czochralski pulling technique has been utilized for formation of certain embodiments herein, it is understood that any one of a number of melt-based techniques and flame-fusion techniques may be utilized. Melt-based techniques include the Bridgman method, the liquefied encapsulated Bridgman method, the horizontal gradient freeze method, and edge-defined growth method, the Stockberger method, or the Kryopolus method. These melt-based techniques fundamentally differ from flame fusion techniques in that melt-based techniques grow a boule from a melt. In contrast, flame fusion does not create a batch melt from which a boule is grown, but rather, provides a constant flow of raw material (such as in powder form), to a hot flame, and the molten product is then projected against a receiving surface on which the molten product solidifies. Due to process control issues, melt-based technologies may be preferred over flame fusion techniques.

Generally, the single seed crystal is contacted with the melt, while rotating the batch melt and the seed crystal relative to each other. Typically, the seed crystal is formed of stoichiometric spinel and has sufficiently high purity and crystallographic homogeneity to provide a suitable template for boule growth. The seed crystal may be rotated relative to a fixed crucible, the crucible may be rotated relative to a fixed seed crystal, or both the crucible and the seed crystal may be rotated. During rotation, the seed crystal and the actively forming boule are drawn out of the melt.

Typically, the boule consists essentially of a single spinel phase, with no secondary phases. According to another feature, the boule and the components processed therefrom are free of impurities and dopants.

For non-stoichiometric compositions, the boule may be cooled at relatively high cooling rates such as not less than about 50° C./hour. However, stoichiometric boules are cooled at relatively low cooling rates to prevent fracture during the cooling process. Following cooling, the boules are generally annealed. Annealing is typically carried out on the order of 300 hours, while other embodiments, such as those using a non-stoichiometric composition are annealed for less than about 50 hours.

Following boule formation, machining operations are generally carried out to form the desired geometric configuration of the optical lens element. Typically, the lens has opposite major surfaces and an optical axis, which is aligned along a particular crystallographic direction. The particular example shown in FIG. 6 shows a convex lens having a flat, planar lower major surface, and a optical axis labeled OA. Generally, the optical axis extends along a particular crystallographic direction. For example, oftentimes the optical axis extends along the <111>, <100>, <110>, or <122> crystallographic direction. In one embodiment, the optical axis extends along one of the <111>, <100>, and <110> crystallographic directions. Alignment along the <111> direction may be preferred for certain embodiments. Crystallographic orientation as described may improve performance by reducing optical distortion, aberration, or general light deviations due to birefringence at high frequencies, such as in the DUV range. Birefringence is believed to be due to residual material stress in the element. Generally the optical lens element has a circular or round outer periphery.

Following machining, the optical lens element may be coated with an anti-reflective coating (ARC), particularly for high performance applications. An example of a suitable ARC includes colloidal silica.

While embodiments herein have been specifically described with respect to immersion lithography, it is to be understood that aspects of the present invention may also be implemented in dry lithography as well.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. An optical lens element, comprised of single crystal spinel material, the optical element having an optical transmittance of not less than 75%, wherein the optical lens element has opposite major surfaces, at least one of which has an anti-reflective coating.

2. (canceled)

3. (canceled)

4. The optical lens element of claim 1, wherein the element has an optical axis extending along the <111>, <100>, <110>, or <112> crystallographic direction.

5. The optical lens element of claim 4, wherein the optical axis extends along the <111>, <100>, <110> crystallographic direction.

6. The optical lens element of claim 5, wherein the optical axis extends along the <111> crystallographic direction.

7. The optical lens element of claim 1, wherein the optical lens element has opposite major surfaces, at least one of which is concave or convex.

8. (canceled)

9. (canceled)

10. (canceled)

11. The optical lens element of claim 1, wherein the spinel material has the general formula aAD.bE₂D₃, wherein A is selected from the group consisting of Mg, Ca, Zn, Mn, Ba, Sr, Cd, Fe, and combinations thereof, E is selected from the group consisting Al, In, Cr, Sc, Lu, Fe, and combinations thereof, and D is selected from the group consisting O, S, Se, and combinations thereof, wherein a ratio b:a≧1:1.

12. (canceled)

13. (canceled)

14. The optical lens element of claim 1, wherein A is Mg, D is O, and E is Al, such that the single crystal spinel has the formula aMgO.bAl₂O₃.

15. (canceled)

16. (canceled)

17. (canceled)

18. A lithographic patterning apparatus, comprising:
a radiation source;
a mask having a pattern arranged downstream of the radiation source, the mask receiving radiation to provide a patterned beam;
a projection optic for projecting the patterned beam onto a substrate, the projection optic comprising multiple optical lens elements, at least one of which is comprised of single crystal spinel material; and
a substrate table for receiving the substrate.

19. The lithographic patterning apparatus of claim 18, wherein the projection optic has a distal end defined by a distal optical lens element arranged closest to the substrate table, the distal optical lens element being comprised of the single crystal spinel material.

20. The lithographic patterning apparatus of claim 19, further comprising a containment structure for containing a fluid between the distal optical lens element and the substrate, the projection optic being arranged such that the distal optical lens element contacts the fluid.

21. (canceled)

22. (canceled)

23. The lithographic patterning apparatus of claim 18, wherein the optical lens element comprised of single crystal spinel material has opposite major surfaces, at least one of which has an anti-reflective coating provided thereon.

24. (canceled)

25. The lithographic patterning apparatus of claim 18, wherein the optical lens element comprised of single crystal spinel material has an optical transmittance is not less than 80%.

26. (canceled)

27. The lithographic patterning apparatus of claim 18, wherein the optical lens element comprised of single crystal spinel material has an optical axis extending along the <111> or the <100> crystallographic direction.

28. The lithographic patterning apparatus of claim 27, wherein the optical axis extends along the <111> crystallographic direction.

29. The lithographic patterning apparatus of claim 18, wherein the spinel material has the general formula aAD.bE₂D₃, wherein A is selected from the group consisting of Mg, Ca, Zn, Mn, Ba, Sr, Cd, Fe, and combinations thereof, E is selected from the group consisting Al, In, Cr, Sc, Lu, Fe, and combinations thereof, and D is selected from the group consisting O, S, Se, and combinations thereof, wherein a ratio b:a≧1:1.

30. (canceled)

31. (canceled)

32. The lithographic patterning apparatus of claim 29, wherein A is Mg, D is O, and E is Al, such that the single crystal spinel has the formula aMgO.bAl₂O₃.

33. (canceled)

34. The lithographic patterning apparatus of claim 18, wherein the radiation source transmits radiation at a wavelength not greater than about 300 nm.

35. (canceled)

36. A method of processing a semiconductor device, comprising:
providing a photoresist on a semiconductor device;
irradiating a patterned beam onto the semiconductor device to expose portions of the photoresist, wherein irradiating includes projecting the patterned beam through a projection optic, the projection optic comprising multiple optical lens elements, at least one of which is comprised of single crystal spinel material.

37. The method of claim 36, further comprising removing portions of the photoresist leaving behind a pattern of exposed portions of the semiconductor device.

38. (canceled)

39. (canceled)

40. (canceled)

41. The method of claim 36, further comprising providing a liquid between the semiconductor device and the projection optic.

42. (canceled)

43. (canceled)

44. (canceled)

45. (canceled)
